(19) United States
(12) Patent Application Publication
(10) Pub. No.: US 2026/0287422 A1
(43) Pub. Date: Sep. 24, 2026

(54) INFORMATION GENERATION APPARATUS, INFORMATION GENERATION SYSTEM, AND INFORMATION GENERATION METHOD

(71) Applicant: Sony Semiconductor Solutions Corporation, Atsugi-shi, Kanagawa (JP)

(72) Inventor: Seichi OTSUKI, Kanagawa (JP)

(73) Assignee: Sony Semiconductor Solutions Corporation, Atsugi-shi, Kanagawa (JP)

(21) Appl. No.: 19/475,444

(22) PCT Filed: Apr. 18, 2024
(86) PCT No.: PCT/JP2024/015480

§ 371 Date: Oct. 15, 2025

Related U.S. Application Data
(60) Provisional application No. 63/462,008, filed on Apr. 26, 2023.

(51) Int. Cl. G01J 3/02; G01J 3/28

(52) U.S. Cl. CPC G01J 3/0224; G01J 3/2823

(57) ABSTRACT

It is desirable to provide information associated with information regarding polarization for an application and the like with machine learning. An information generation apparatus includes a spectroscopic information processing unit that generates polarization degree information that indicates wavelength dependency of a polarization degree from first spectroscopic information that is an imaging signal for each of a plurality of wavelength bands from a first spectroscopic camera and second spectroscopic information that is an imaging signal of the plurality of wavelength bands of light received by a second spectroscopic camera via a polarizing filter.

### CROSS REFERENCE TO RELATED APPLICATIONS

This application claims priority to, and the benefit of, U.S. provisional patent application Ser. No. 63/462,008 filed on Apr. 26, 2023, incorporated herein by reference in its entirety.

### TECHNICAL FIELD

The present technology relates to an information generation apparatus, an information generation system, and an information generation method, and relates to an information generation technology using a spectroscopic camera.

### BACKGROUND ART

In an application with machine learning, its performance is improved as the amount of input information increases. One of methods for increasing information other than spatial information in an image processing application is a method using a spectroscopic camera. The accuracy of semantic segmentation or the like is improved by adding information other than the space and the three colors of R (red), G (green), and B (blue).

PTL 1 below discloses a technique for an apparatus for image segmentation of an image of a scene including an object assuming medical use for analyzing skin and the like.

### CITATION LIST

### Patent Literature

PTL 1: JP 2021-520274 W

### SUMMARY

### Technical Problem

In an application with machine learning for an image, a system capable of providing various types of information in order to further improve accuracy is desired.

Therefore, the present disclosure proposes novel information generation in a case where a spectroscopic camera is used.

### Solution to Problem

An information generation apparatus according to the present technology includes a spectroscopic information processing unit that generates polarization degree information that indicates wavelength dependency of a polarization degree from first spectroscopic information that is an imaging signal for each of a plurality of wavelength bands from a first spectroscopic camera and second spectroscopic information that is an imaging signal of the plurality of wavelength bands of light received by a second spectroscopic camera via a polarizing filter.

It is assumed that one of the first and second spectroscopic cameras receives light trough a polarizing filter. With this configuration, first and second spectroscopic information having different polarization components are obtained, and the first and second spectroscopic information is processed to generate information.

### BRIEF DESCRIPTION OF DRAWINGS

FIG. 1 is a block diagram of a related spectroscopic camera according to the present technology.

FIG. 2 is an explanatory diagram of a configuration example of a pixel array section included in a spectroscopic sensor.

FIG. 3 is an explanatory diagram of a band narrowing process of the spectroscopic camera.

FIG. 4 is a block diagram of an information generation apparatus according to the embodiment.

FIG. 5 is an explanatory diagram of imaging of a plant according to the embodiment.

FIG. 6 is an explanatory diagram of a difference depending on the presence or absence of a polarizing filter according to the embodiment.

FIG. 7 is an explanatory diagram of processing of the spectroscopic information processing unit according to the embodiment.

FIG. 8 is an explanatory diagram of processing of a distance information calculation unit according to the embodiment.

FIG. 9 is an explanatory diagram of luminance image generation processing according to the embodiment.

FIG. 10 is an explanatory diagram of parallax information according to the embodiment.

FIG. 11 is an explanatory diagram of correction processing for a luminance image according to the embodiment.

FIG. 12 is a block diagram of an information processing apparatus serving as the spectroscopic information generation apparatus according to the embodiment.

FIG. 13 is a block diagram of a computer-based system on which embodiments of the present system may be implemented.

### DESCRIPTION OF EMBODIMENTS

Hereinafter, embodiments will be described in the following order.
<1. Spectroscopic camera>
<2. Configuration and processing of information generation system>
<3. Configuration of information processing apparatus>
<4. Notes>
<5. Summary and modification example>

### <1. Spectroscopic Camera>

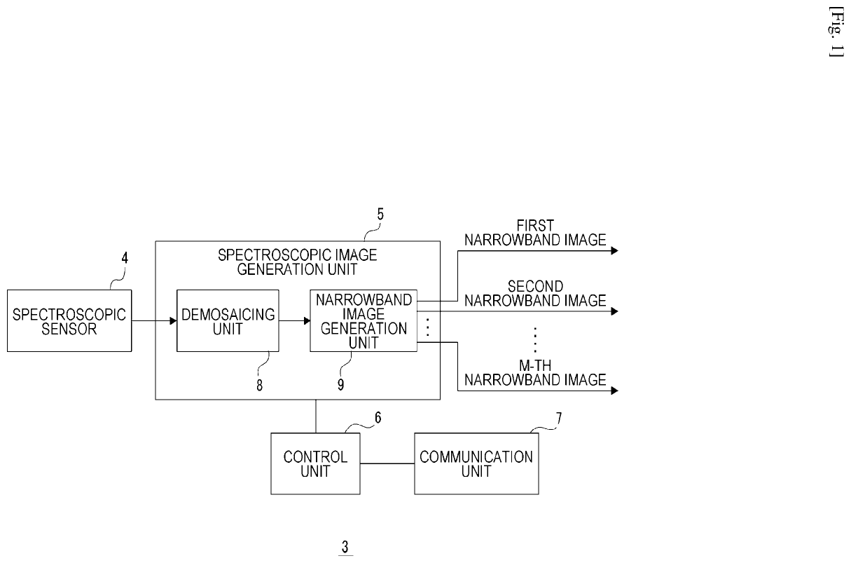

An example of a spectroscopic camera related to the present technology will be described with reference to FIGS. 1 to 3.

FIG. 1 is a block diagram illustrating a schematic configuration example of a spectroscopic camera 3.

Here, the “spectroscopic camera” represents a camera including a spectroscopic sensor as a light receiving sensor. The “spectroscopic sensor” is a light receiving sensor for obtaining a plurality of narrowband images to be used as a wavelength characteristic analysis image for light from a subject.

As illustrated, the spectroscopic camera 3 includes a spectroscopic sensor 4, a spectroscopic image generation unit 5, a control unit 6, and a communication unit 7.

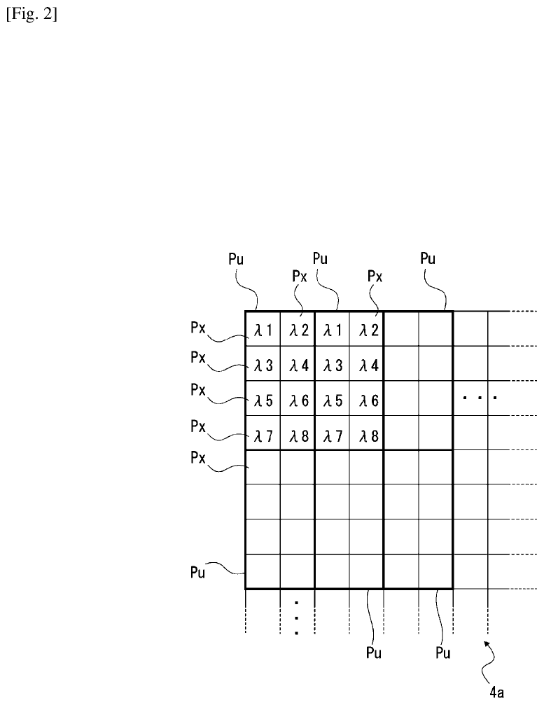

FIG. 2 is a diagram schematically illustrating a configuration example of a pixel array section 4a included in the spectroscopic sensor 4.

As illustrated, in the pixel array section 4a, a spectroscopic pixel unit Pu in which a plurality of pixels Px each receiving light of different wavelength bands is two-dimensionally arranged in a predetermined pattern is formed. The pixel array section 4a includes a plurality of spectroscopic pixel units Pu arranged two-dimensionally.

In the example of the drawing, an example in which each of the spectroscopic pixel units Pu individually receives light of a total of eight wavelength bands of λ1 to 8 in each of the pixels Px, in other words, an example in which the number of wavelength bands divided to be received in each of the spectroscopic pixel units Pu (hereinafter referred to as “number of light receiving wavelength channels”) is “8” is illustrated, but this is merely an example for description, and the number of light receiving wavelength channels in the spectroscopic pixel unit Pu may be any number more than one, and can be arbitrarily set.

Hereinafter, the number of light receiving wavelength channels in the spectroscopic pixel unit Pu is referred to as “N”.

In FIG. 1, the spectroscopic image generation unit 5 generates M narrowband images on the basis of a RAW image as an image output from the spectroscopic sensor 4. Here, it is assumed that “M>N”, and for example, M=41 and the like in a case where N=8.

The spectroscopic image generation unit 5 includes a demosaicing unit 8 and a narrowband image generation unit 9. The demosaicing unit 8 performs demosaicing processing on the RAW image from the spectroscopic sensor 4, and the narrowband image generation unit 9 performs band narrowing processing (linear matrix processing) on the basis of each of the N-channel wavelength band images obtained by the demosaicing processing, thereby generating M narrowband images from the N wavelength band images.

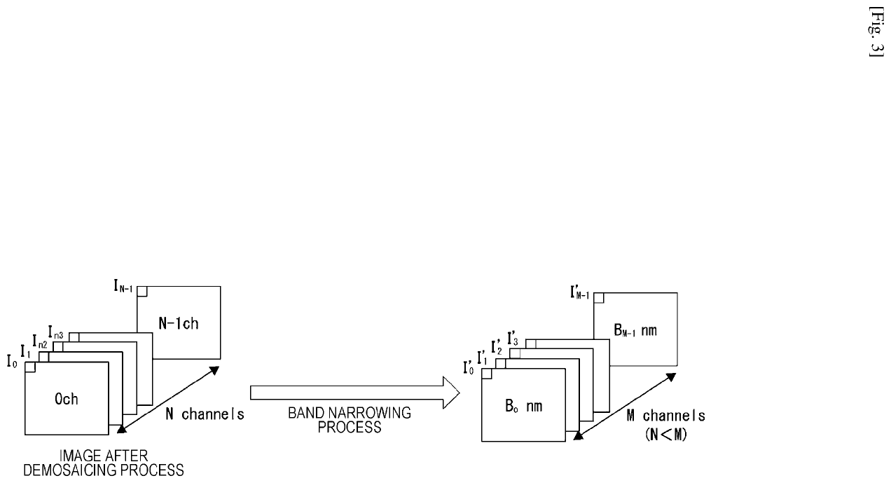

FIG. 3 is an explanatory diagram of the band narrowing processing for obtaining M narrowband images.

Based on the wavelength band images for N channels obtained by the demosaicing processing by the demosaicing unit 8, for example, matrix operation as illustrated is performed for every pixel position to obtain narrowband images for M channels. In order to convert the wavelength band images for N channels into narrowband images for M channels in this manner, processing of obtaining pixel values (in the figure, I0 to IN-1) for M channels by matrix operation using the pixel values (in the figure, I′0 to I′M-1) for N channels for every pixel position is the band narrowing processing.

Here, in a case where a pixel value after demosaicing processing is R, an input wavelength channel is n (0 to N-1), a narrowing coefficient is C, an output pixel value by the band narrowing processing is B, and an output wavelength channel is m (0 to M-1), an arithmetic expression of the band narrowing processing can be expressed by the following [Equation 1].

$$[ Math . 1 ]$$

$$B m = {\sum }_{n = 0}^{N - 1} ( R [ n ] * C m [ n ] ) \qquad [ Equation 1 ]$$

In other words, the pixel value B0 of the m=Oth output wavelength channel=R[0]×C0[0]+R[1]×C0[1]+R[2]×C0[2]+, . . . +R[N-1]×C0[N-1], and the pixel value B1 of the m=1st output wavelength channel=R[0]×C1[0]+R[1]×C1[1]+R[2]×C1[2]+, . . . +R[N-1]×C1[N-1].

Thereafter, similarly, the pixel value BM-1 of the last m=M-1 output wavelength channel=R[0]×CM-1[0]+R[1]×CM−1[1]+R[2]×CM−1[2]+, . . . +R[N-1]×CM−1[N-1].

At this time, as the narrowing coefficient C, a total of N×M of C0[0] to C0[N-1] for obtaining the pixel value B0, C1 [0] to C1[N-1], . . . for obtaining the pixel value B1, and CM −1[0] to CM −1[N-1] for obtaining the pixel value BM-1 are used.

In FIG. 1, the control unit 6 includes a microcomputer including, for example, a central processing unit (CPU), a read only memory (ROM), a random access memory (RAM), and the like, and performs overall control of the spectroscopic camera 3 by the CPU executing processing on the basis on, for example, a program stored in the ROM or a program loaded in the RAM.

The communication unit 7 performs wired or wireless data communication with an external device. For example, the communication unit 7 may be configured to perform wired data communication with an external device according to a predetermined wired communication standard such as a universal serial bus (USB) communication standard, wireless data communication with an external device according to a predetermined wireless communication standard such as a Bluetooth (registered trademark) communication standard and the like, or wireless or wired data communication with an external device via a predetermined network such as the Internet.

The control unit 6 can transmit and receive data to and from an external device via the communication unit 7.

### <2. Configuration and Processing of Information Generation System>

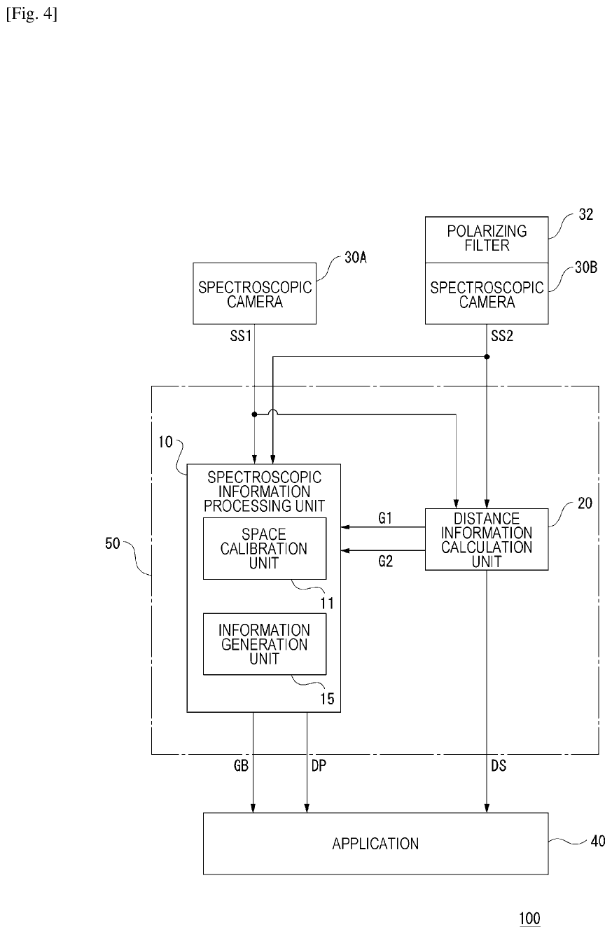

Information generation system 100 according to the present embodiment using the above-described spectroscopic camera will be described. FIG. 4 is a block diagram of the information generation system 100 according to the embodiment.

The information generation system 100 includes two spectroscopic cameras 30A and 30B and an information generation apparatus 50. The spectroscopic camera 30A outputs spectroscopic information SS1, and the spectroscopic camera 30B outputs spectroscopic information SS2.

Each of the spectroscopic cameras 30A and 30B is a configuration of the spectroscopic camera 3 described with reference to FIGS. 1 to 3, and outputs a plurality of narrowband images. In FIG. 4, information including a plurality of narrowband images is illustrated as spectroscopic information SS1 and SS2.

Alternatively, the spectroscopic cameras 30A and 30B here may be considered to correspond to the spectroscopic sensor 4 in FIG. 1. In this case, the spectroscopic information SS1 and SS2 in FIG. 4 is information including RAW images of the number of light receiving wavelength channels of the spectroscopic sensor 4.

The spectroscopic camera 30A and the spectroscopic camera 30B include a spectroscopic sensor 4 that images a plurality of common wavelength bands by the pixel array section 4a as illustrated in FIG. 2, for example. The spectroscopic camera 30A includes, for example, the spectroscopic sensor 4 for eight channels that receive the wavelength bands κ1 to 8 for each pixel, and the spectroscopic camera 30B also includes the spectroscopic sensor 4 for eight channels that receive the wavelength bands κ1 to 8, which are a plurality of common wavelength bands, for each pixel.

Here, a polarizing filter 32 is mounted in the spectroscopic camera 30B side. Therefore, each of the spectroscopic images of the spectroscopic information SS1 and the spectroscopic information SS2 has a different degree of the polarization component.

Each piece of the spectroscopic information SS1 and SS2 is supplied to a spectroscopic information processing unit 10.

The spectroscopic information processing unit 10 includes a space calibration unit 11 and an information generation unit 15.

The space calibration unit 11 performs processing of canceling the parallax between the spectroscopic information SS1 and the spectroscopic information SS2. The spectroscopic information SS1 includes, for example, image data of 8 channels (alternatively, narrowband image data of more multiple channels) captured by the spectroscopic camera 30 A. The spectroscopic information SS2 includes, for example, image data of 8 channels (alternatively, narrowband image data of more multiple channels) captured by the spectroscopic camera 30B. Then, the image data of the spectroscopic information SS1 and the image data of the spectroscopic information SS2 include parallax caused by the difference between the physical positions of the spectroscopic cameras 30A and 30B. The space calibration unit 11 calculates the parallax and aligns the images with each other (cancels the parallax).

The information generation unit 15 generates and outputs polarization degree information DP and output spectroscopic information GB using the spectroscopic information SS1 and SS2.

Each piece of the spectroscopic information SS1 and SS2 is also supplied to a distance information calculation unit 20.

The distance information calculation unit 20 calculates the distance to the subject using the parallax existing in the spectroscopic information SS1 and SS2, and outputs the distance as distance information DS.

Note that the information generation apparatus 50 can be configured by, for example, one or a plurality of processors (information processing apparatuses). The processing of the spectroscopic information processing unit 10 and the distance information calculation unit 20 described above may be executed by an arithmetic function of the processor on the basis of a software program.

An application 40 refers to machine learning application software that performs semantic segmentation and the like, for example. Although illustrated as blocks for convenience in the drawing, the application 40 may be, for example, a processing function implemented by a program activated in a processor as the information generation apparatus 50 or a processing function implemented by a program activated in another processor.

According to the present embodiment, accuracy of semantic segmentation by the application 40 is improved by inputting the polarization degree information DP, the output spectroscopic information GB, and the distance information DS generated by the spectroscopic information processing unit 10 to the application 40.

By using the plurality of spectroscopic cameras 30A and 30B, it is possible to obtain optical conditions having different polarization components, thereby diversifying information to be input for semantic segmentation and improving machine learning accuracy.

Further, even if the amount of information increases, the spatial resolution is maintained by the spatial calibration processing.

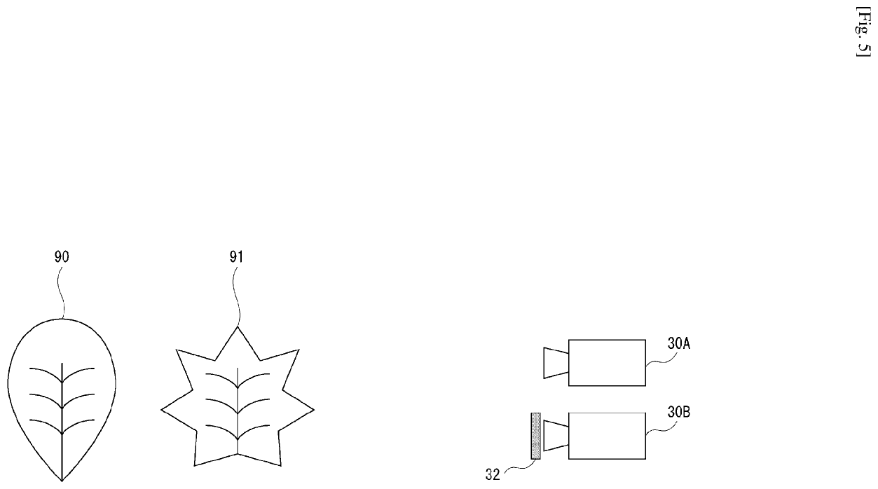

FIG. 5 schematically illustrates how the spectroscopic cameras 30A and 30B capture images of plants 90 and 91. For example, the information generation apparatus 50 generates the polarization degree information DP, the output spectroscopic information GB, and the distance information DS from the spectroscopic information SS1 and SS2 obtained by such imaging, and supplies the polarization degree information DP, the output spectroscopic information GB, and the distance information DS to the application 40. As a result, determination of the type of the plant and determination of the state are performed using semantic segmentation. This enables implementation of various agricultural applications.

In particular, according to the present embodiment, generating the polarization degree information DP is a significant point.

The spectroscopic reflectance of a plant is determined by the components and the structure of the surface. Polarization components also vary depending on the plant. In a case where the outlines of the spectroscopic waveforms are similar, it is difficult to determine only by the spectroscopy. However, in a case where the polarization components are different, it is possible to identify and analyze the plant with higher accuracy as considering the wavelength dependency of the polarization degree and spectroscopic reflectance information.

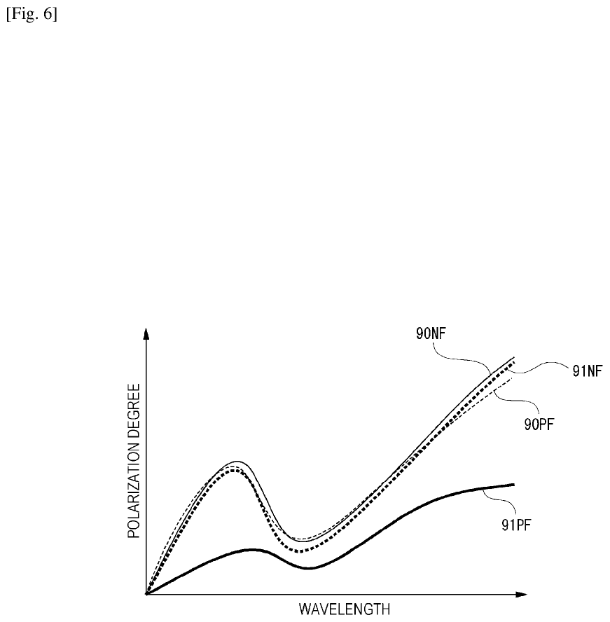

In FIG. 6, the wavelength-polarization degree characteristic of the plants 90 and 91, that is, the wavelength dependency of the polarization degree is illustrated with the wavelength on the horizontal axis and the polarization degree on the vertical axis.

The curve 90NF is a spectroscopic waveform of the plant 90 in a case where the polarizing filter is not provided, the curve 90PF is a spectroscopic waveform of the plant 90 in a case where the polarizing filter is provided, the curve 91NF is a spectroscopic waveform of the plant 91 in a case where the polarizing filter is not provided, and the curve 91PF is a spectroscopic waveform of the plant 91 in a case where the polarizing filter is provided.

In this example, the curves 90NF and 91NF have similar characteristics.

In addition, the curves 90NF and 90PF have similar characteristics.

In addition, the curves 91NF and 91PF have greatly different characteristics.

Then, it can be seen that the polarization component does not contribute much to the spectroscopic image of the plant 90, and on the other hand, the characteristics of the plant 91 greatly change depending on the presence or absence of the polarizing filter 32.

For example, the wavelength dependency of polarized light, that is, the polarization degree information DP is obtained as a difference between the curves 90NF and 90PF for the plant 90, and is obtained as a difference between the curves 91NF and 91PF for the plant 91. Then, since the polarization degree information DP varies depending on the type and state of the plant, the polarization degree information DP becomes significant information for the determination performed by the application 40.

That is, by using the information of the two spectroscopic cameras 30A and 30B having different presence or absence of the polarizing filter 32, it is possible to identify the type and state of the plant with higher accuracy than in the case of using only the spectroscopic information.

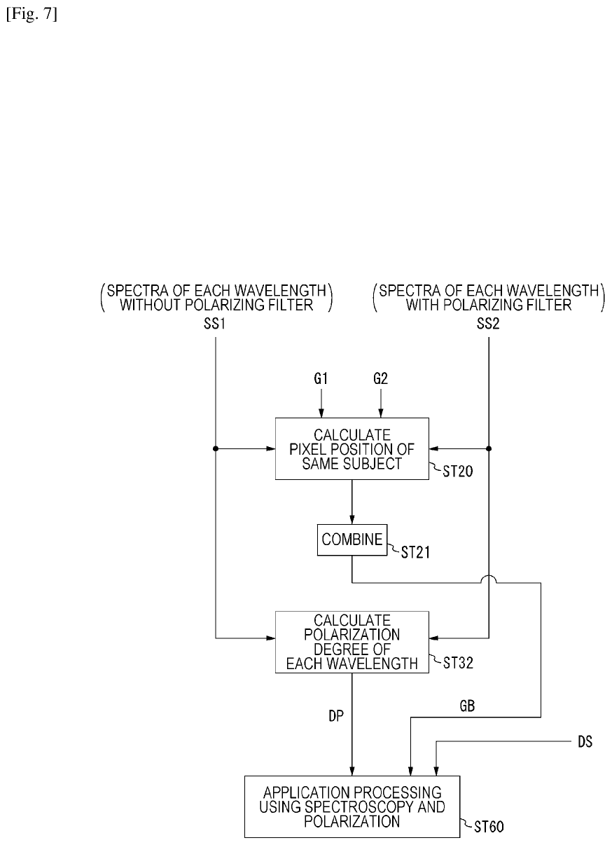

FIG. 7 illustrates processing example of the spectroscopic information processing unit 10. This is a processing example by the functions of the space calibration unit 11 and the information generation unit 15 in the spectroscopic information processing unit 10.

The spectroscopic information processing unit 10 inputs the luminance images G1 and G2 calculated by the processing of the distance information calculation unit 20 as described later. The luminance image G1 is a luminance image generated from the spectroscopic information SS1, and the luminance image G2 is a luminance image generated from the spectroscopic information SS2.

In step ST20, the spectroscopic information processing unit 10 detects the same subject regarding the spectroscopic cameras 30A and 30B from the luminance images G1 and G2 by pattern matching processing. Then, the spectroscopic information processing unit 10 calculates the positions of the pixels of the same subject regarding the spectroscopic camera 30A for the subject regarding the spectroscopic camera 30B, for example. For example, the spatial calibration of the spectroscopic information SS1 and SS2 can be performed by detecting corresponding coordinates of feature points of some subjects, such as coordinates (x2, y2) of the subject in the luminance image G1 corresponding to coordinates (x1, y1) of the subject in the luminance image G2.

In step ST21, processing of adding the spectroscopic information SS2 to the pixel position of the same subject of the spectroscopic information SS1, that is, processing of combining the spectroscopic information SS1 and SS2 is performed on the basis of the result of step ST20. As a result, for example, it is possible to obtain the output spectroscopic information GB in which the spectroscopic images of the eight channels (alternatively, in a case where narrowband image generation processing is performed by the spectroscopic camera 30A, more channels are used) in the spectroscopic information SS1 and the spectroscopic images of the eight channels (alternatively, in a case where narrowband image generation processing is performed by the spectroscopic camera 30B, more channels are used) in the spectroscopic information SS2 are combined. In this case, for example, a spectroscopic image for each of the wavelength bands κ1 to 8 is obtained, and for example, combining is performed so as to take an average value of pixel values in images of the respective wavelength bands κ1 in the spectroscopic information SS1 and SS2. The similar manner applies to the image in the wavelength band λ2 to the image in the wavelength band α. With this configuration, the output spectroscopic information GB with reduced noise component can be obtained.

Furthermore, in step ST21, the spectroscopic information processing unit 10 can obtain the output spectroscopic information GB of a larger number of channels by performing narrowband image generation processing.

In step ST32, the spectroscopic information processing unit 10 calculates the polarization degree for each wavelength. For example, the difference between the average values of the pixel values in the images in the wavelength band λ1 in the spectroscopic information SS1 and SS2 is taken as the polarization degree of the wavelength band λ1. In addition, the similar manner applies to the image of the wavelength band λ2 to the image of the wavelength band λ8, and the polarization degree of each wavelength band is used. The information on the degree of polarization of each wavelength band is information indicating wavelength dependency of the polarization degree.

Alternatively, in this case, narrowband images of a larger number of channels may be generated by performing the narrowband image generation process on the spectroscopic information SS1 and SS2, and the polarization degree information DP indicating the wavelength dependency of the polarization degree may be generated by taking a difference between the narrowband images of the same wavelength band on the basis of the spectroscopic information SS1 and SS2.

The spectroscopic information processing unit 10 provides the polarization degree information DP and the output spectroscopic information GB generated as described above to the application processing (step ST60) by the application 40.

Note that, as illustrated in the drawing, according to the present embodiment, the distance information DS can also be provided to the application processing.

Next, generation of the distance information DS will be described.

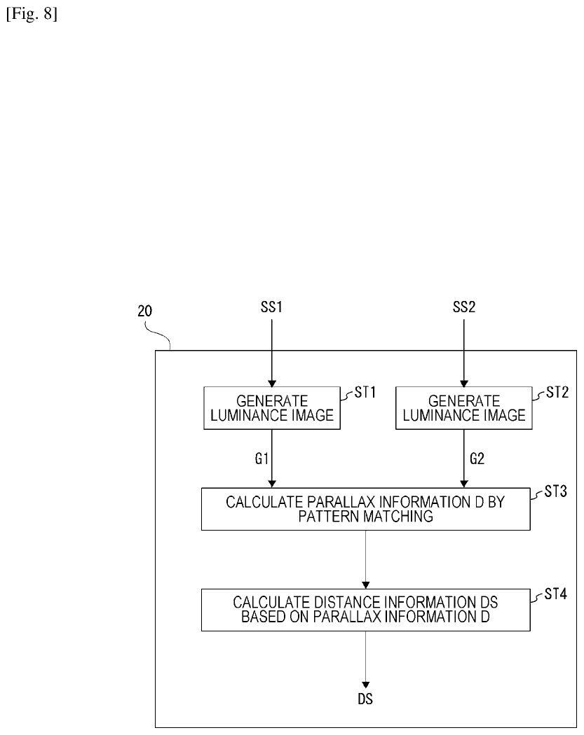

FIG. 8 illustrates processing example of the distance information calculation unit 20.

At step ST1, the distance information calculation unit 20 performs processing of generating the luminance image G1 from the spectroscopic information SS1. In addition, in step ST2, the distance information calculation unit 20 performs the processing of generating the luminance image G2 from the spectroscopic information SS2.

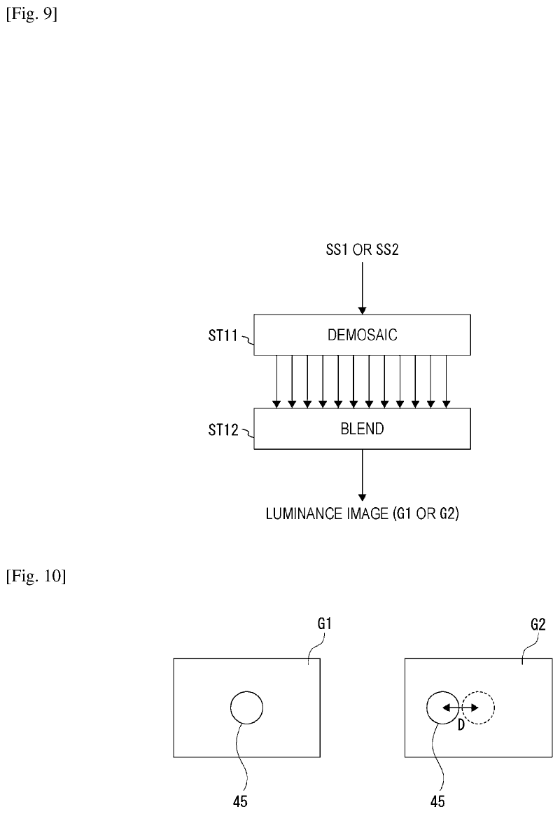

The luminance images G1 and G2 are used as images for parallax calculation, and the distance information calculation unit 20 performs the processing illustrated in FIG. 9 as the luminance image generation process in steps ST1 and ST2.

The distance information calculation unit 20 performs a demosaicing process in step ST11. This is a general demosaicing process using bilinear interpolation and the like that aligns the spatial phase of each wavelength pixel.

The distance information calculation unit 20 performs a blending process in step ST12. For example, the signals of the respective wavelengths are averaged. In a case where there are many pieces of edge information at a specific wavelength, weighted addition or selection with a large weight given to the edge information and the like may be performed.

Through the above process, the luminance image G1 is generated from the spectroscopic information SS1, and the luminance image G2 is generated from the spectroscopic information SS2.

Note that the luminance images G1 and G2 are also provided to the spectroscopic information processing unit 10 for the processing of step ST20 in FIG. 7.

In step ST3 of FIG. 8, the distance information calculation unit 20 performs processing of calculating the parallax information D by pattern matching with respect to the arrangement direction of the spectroscopic cameras 30A and 30B.

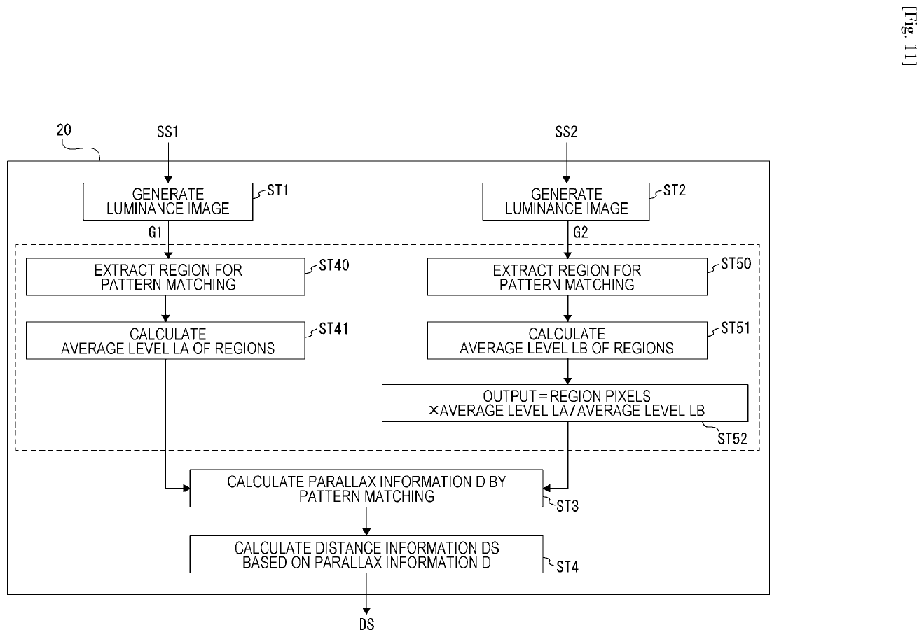

FIG. 10 illustrates parallax corresponding to the parallax information D.

For example, the distance information calculation unit 20 extracts the subject 45 in the luminance image G2 of the spectroscopic camera 30B, performs pattern matching, and detects the same subject 45 in the luminance image G1. Then, a difference in coordinates of the position of the subject 45 between the luminance images G1 and G2 is the parallax information D.

In step ST4 of FIG. 8, the distance information calculation unit 20 calculates the distance information DS from the parallax information D on the basis of the principle of triangulation.

For example, in a case where the inter-camera distance B, the focal length F, and the parallax D are set,

$$Distance information DS = ( B \times F ) / D$$

is obtained.

The distance information calculation unit 20 outputs the distance information DS generated in this manner to the application 40.

Note that the distance information calculation unit 20 may perform calculation processing of the distance information DS as illustrated in FIG. 11. In addition to steps ST1 to ST4 in FIG. 8, steps ST40, ST41, ST50, ST51, and ST52 indicated by broken lines are performed. This is correction processing of a difference generated in the luminance images G1 and G2 due to the influence of the polarizing filter 32.

In step ST40, the distance information calculation unit 20 extracts a region for pattern matching in the luminance image G1.

In step ST41, the distance information calculation unit 20 calculates an average level LA of pixel values in the extracted region.

In step ST50, the distance information calculation unit 20 extracts a region for pattern matching in the luminance image G2.

In step ST51, the distance information calculation unit 20 calculates an average level LB of pixel values in the extracted region.

In step ST52, the distance information calculation unit 20 performs processing of multiplying each pixel value of the extracted region by the average level LA and dividing the average level LB.

That is, the region for pattern matching in the luminance image G2 is corrected so as to be matched with the luminance image G1. Then, in step ST3, parallax information D is calculated by pattern matching in the extracted region. With this configuration, the image conditions of the luminance images G1 and G2 are made similar, and the pattern matching accuracy can be improved.

### <3. Configuration of Information Processing Apparatus>

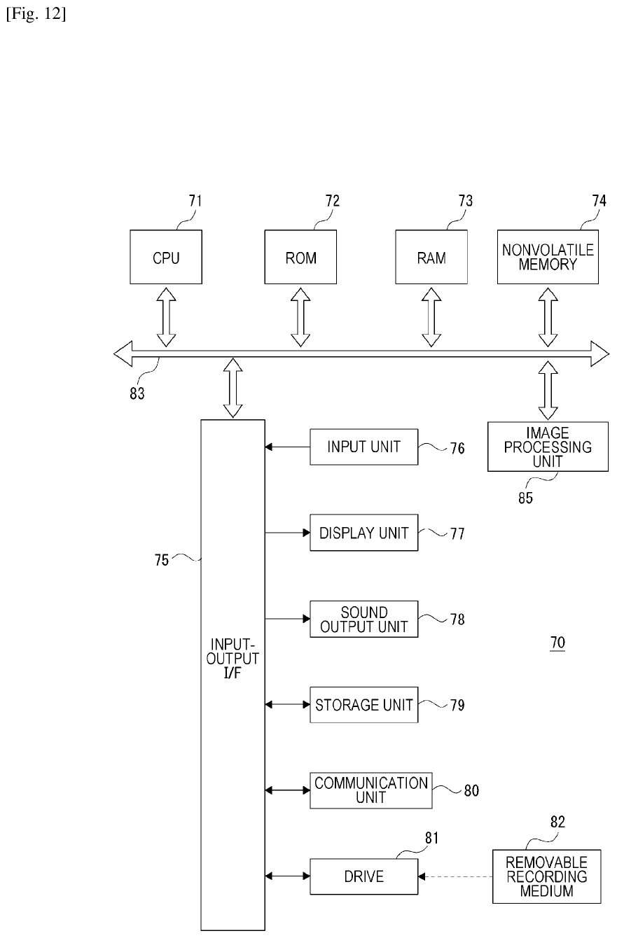

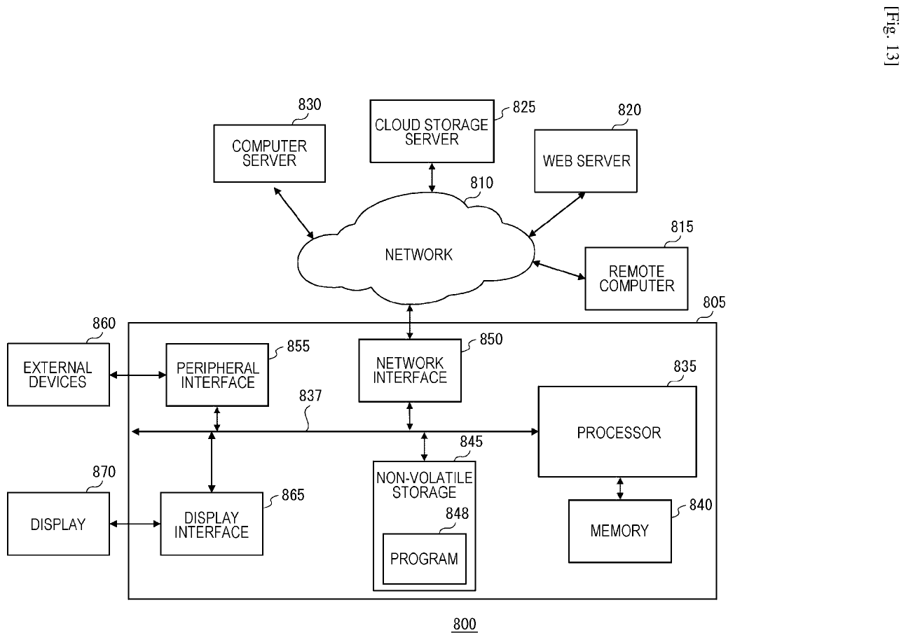

A configuration example of the information processing apparatus 70 applicable as the information generation apparatus 50 will be described with reference to FIG. 12.

The information processing apparatus 70 is a device capable of performing information processing, such as a computer device. Specifically, a microprocessor and a peripheral device, a personal computer, a workstation, a portable terminal device such as a smartphone and a tablet, and the like are assumed as the information processing apparatus 70. Furthermore, the information processing apparatus 70 may be a computer device configured as a server device or an arithmetic device in cloud computing.

A central processing unit (CPU) 71 of the information processing apparatus 70 illustrated in FIG. 12 executes various types of processes in accordance with a program stored in a nonvolatile memory unit 74 such as a read only memory (ROM) 72 or, for example, an electrically erasable programmable read-only memory (EEP-ROM), or a program loaded from the storage unit 79 to a random access memory (RAM) 73. Furthermore, the RAM 73 also appropriately stores data and the like necessary for the CPU 71 to execute various processes.

The image processing unit 85 performs various types of image processing. For example, any one of image synthesis, image analysis processing, image signal processing including color/luminance adjustment processing and color conversion processing, image editing processing, and the like, or a plurality of processing is performed.

The image processing unit 85 can be realized by, for example, a CPU, a graphics processing unit (GPU), a general-purpose computing on graphics processing units (GPGPU), an artificial intelligence (AI) processor, and the like that is separate from the CPU 71.

Note that the image processing unit 85 may be provided as a function in the CPU 71.

The CPU 71, the ROM 72, the RAM 73, the nonvolatile memory unit 74, and the image processing unit 85 are connected to one another via a bus 83. An input-output interface 75 is also connected to the bus 83.

To the input-output interface 75, an input unit 76 configured with an operation element and an operation device is connected. For example, as the input unit 76, various operators and operation devices such as a keyboard, a mouse, a key, a trackball, a dial, a touch panel, a touch pad, a remote controller and the like are assumed.

A user operation is detected by the input unit 76, and a signal corresponding to the input operation is interpreted by the CPU 71.

A microphone is also assumed as the input unit 76. A voice uttered by the user can also be input as the operation information.

Furthermore, a display unit 77 including a liquid crystal display (LCD), an organic electro-luminescence (EL) panel, or the like, and an audio output unit 78 including a speaker or the like are integrally or separately connected to the input-output interface 75.

The display unit 77 is a display unit that performs various types of displays, and includes, for example, a display device provided in a housing of the information processing apparatus 70, a separate display device connected to the information processing apparatus 70, and the like.

The display unit 77 displays various images, operation menus, icons, messages, and the like on the display screen, that is, as a GUI, on the basis of an instruction from the CPU 71.

In some cases, a storage unit 79 or a communication unit 80 including a hard disk drive (HDD), a solid state drive (SSD), or the like is connected to the input-output interface 75.

The storage unit 79 can store various data and programs. A database can be configured in the storage unit 79.

The communication unit 80 performs communication processing via a transmission path such as the Internet, wired/wireless communication with various devices such as an external database, an editing device, and an information processing apparatus, bus communication, and the like.

Furthermore, a drive 81 is also connected to the input-output interface 75 as necessary, and a removable recording medium 82 such as a magnetic disk, an optical disk, a magneto-optical disk, a semiconductor memory, or the like is appropriately mounted.

The drive 81 can read video data, various computer programs, and the like from the removable recording medium 82. The read data is stored in the storage unit 79, and video and audio included in the data are output by the display unit 77 and the audio output unit 78. In addition, the computer program and the like read from the removable recording medium 82 are installed in the storage unit 79, as necessary.

In the information processing apparatus 70, for example, software for the processing of the present embodiment can be installed via network communication by the communication unit 80 or the removable recording medium 82. Alternatively, the software may be stored in advance in the ROM 72, the storage unit 79, and the like.

The information processing apparatus 70 can function as the information generation apparatus 50 according to the embodiment by installing a program for executing the processing described in FIGS. 7, 8, 9, and 11 in the CPU 71.

### <4. Notes>

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

The methods and systems described herein may be implemented using computer programming or engineering techniques including computer software, firmware, hardware or any combination or subset thereof, wherein the technical effects may include at least lossless encoding and decoding using inverse orthogonal transforms in an image processing system.

FIG. 13 illustrates a block diagram of a computer that may implement the various embodiments described herein.

The present disclosure may be embodied as a system, a method, and/or a computer program product. The computer program product may include a computer readable storage medium on which computer readable program instructions are recorded that may cause one or more processors to carry out aspects of the embodiment.

The computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A nonexhaustive list of more specific examples of the computer readable storage medium includes each of the following (and appropriate combinations): flexible disk, hard disk, solid-state drive (SSD), random access memory (RAM), read-only memory (ROM), erasable programmable readonly memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely on a user's personal computer, notebook computer, tablet, or smartphone, entirely on a remote computer or compute server, or any combination of these computing devices. The remote computer or compute server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

The computer readable program instructions that may implement the systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

FIG. 13 is a functional block diagram illustrating a networked system 800 of one or more networked computers and servers. In an embodiment, the hardware and software environment illustrated in FIG. 13 may provide an exemplary platform for implementation of the software and/or methods according to the present disclosure.

Referring to FIG. 13, a networked system 800 may include, but is not limited to, computer 805, network 810, remote computer 815, web server 820, cloud storage server 825 and compute server 830. In some embodiments, multiple instances of one or more of the functional blocks illustrated in FIG. 13 may be employed.

Additional detail of computer 805 is shown in FIG. 13. The functional blocks illustrated within computer 805 are provided only to establish exemplary functionality and are not intended to be exhaustive. And while details are not provided for remote computer 815, web server 820, cloud storage server 825 and compute server 830, these other computers and devices may include similar functionality to that shown for computer 805.

Computer 805 may be a personal computer (PC), a desktop computer, laptop computer, tablet computer, netbook computer, a personal digital assistant (PDA), a smart phone, or any other programmable electronic device capable of communicating with other devices on network 810.

Computer 805 may include processor 835, bus 837, memory 840, non-volatile storage 845, network interface 850, peripheral interface 855 and display interface 865. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC).

Processor 835 may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

Bus 837 may be a proprietary or industry standard high-speed parallel or serial peripheral interconnect bus, such as ISA, PCI, PCI Express (PCI-e), AGP, and the like.

Memory 840 and non-volatile storage 845 may be computer-readable storage media. Memory 840 may include any suitable volatile storage devices such as Dynamic Random Access Memory (DRAM) and Static Random Access Memory (SRAM). Non-volatile storage 845 may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

Program 848 may be a collection of machine readable instructions and/or data that is stored in non-volatile storage 845 and is used to create, manage and control certain software functions that are discussed in detail elsewhere in the present disclosure and illustrated in the drawings. In some embodiments, memory 840 may be considerably faster than non-volatile storage 845. In such embodiments, program 848 may be transferred from non-volatile storage 845 to memory 840 prior to execution by processor 835.

Computer 805 may be capable of communicating and interacting with other computers via network 810 through network interface 850. Network 810 may be, for example, a local area network (LAN), a wide area network (WAN) such as the Internet, or a combination of the two, and may include wired, wireless, or fiber optic connections. In general, network 810 can be any combination of connections and protocols that support communications between two or more computers and related devices.

Peripheral interface 855 may allow for input and output of data with other devices that may be connected locally with computer 805. For example, peripheral interface 855 may provide a connection to external devices 860. External devices 860 may include devices such as a keyboard, a mouse, a keypad, a touch screen, and/or other suitable input devices. External devices 860 may also include portable computer-readable storage media such as, for example, thumb drives, portable optical or magnetic disks, and memory cards. Software and data used to practice embodiments of the present disclosure, for example, program 848, may be stored on such portable computer-readable storage media. In such embodiments, software may be loaded onto non-volatile storage 845 or, alternatively, directly into memory 840 via peripheral interface 855. Peripheral interface 855 may use an industry standard connection, such as RS-232 or Universal Serial Bus (USB), to connect with external devices 860.

Display interface 865 may connect computer 805 to display 870. Display 870 may be used, in some embodiments, to present a command line or graphical user interface to a user of computer 805. Display interface 865 may connect to display 870 using one or more proprietary or industry standard connections, such as VGA, DVI, DisplayPort and HDMI.

As described above, network interface 850, provides for communications with other computing and storage systems or devices external to computer 805. Software programs and data discussed herein may be downloaded from, for example, remote computer 815, web server 820, cloud storage server 825 and compute server 830 to non-volatile storage 845 through network interface 850 and network 810. Furthermore, the systems and methods described in this disclosure may be executed by one or more computers connected to computer 805 through network interface 850 and network 810. For example, in some embodiments the systems and methods described in this disclosure may be executed by remote computer 815, computer server 830, or a combination of the interconnected computers on network 810.

Data, datasets and/or databases employed in embodiments of the systems and methods described in this disclosure may be stored and or downloaded from remote computer 815, web server 820, cloud storage server 825 and computer server 830. Combination of connections and protocols that support communications between two or more computers and related devices.

Obviously, numerous modifications and variations of the present invention are possible in light of the above teachings. It is therefore to be understood that within the scope of the appended claims, the invention may be practiced otherwise than as specifically described herein.

### 5. Summary and Modification Example

According to the above embodiments, the following effects can be obtained.

The information generation system 100 according to the embodiment includes the spectroscopic camera 30A that outputs spectroscopic information SS1 that is an imaging signal for each of a plurality of wavelength bands, the spectroscopic camera 30B that outputs spectroscopic information SS2 that is an imaging signal of a plurality of wavelength bands received via the polarizing filter 32, and the information generation apparatus 50. In addition, the information generation apparatus 50 includes the spectroscopic information processing unit 10 that generates polarization degree information DP indicating the wavelength dependency of the polarization degree from the spectroscopic information SS1 and SS2 (see FIG. 4).

Since the spectroscopic information SS1 and the spectroscopic information SS2 have polarization components different from each other, the polarization degree information DP indicating the polarization degree for each wavelength band can be obtained. The polarization degree information DP is useful information for determining the type and state of the plant, for example. For example, this also contributes to improvement of accuracy of a machine learning application such as semantic segmentation.

According to the embodiment, an example has been described in which the spectroscopic information processing unit 10 generates the polarization degree information DP by obtaining the difference for each wavelength band with respect to the spectroscopic information SS1 and SS2 (see FIG. 7).

Since the spectroscopic information SS1 and SS2 are information of spectroscopic sensitivity in the case of passing through the polarizing filter 32 and the case of not passing through the polarizing filter in the same plurality of wavelength bands, if a difference is obtained for each wavelength band, the spectroscopic information SS1 and SS2 becomes information indicating wavelength dependency of polarized light.

According to the embodiment, an example has been described in which the spectroscopic information processing unit 10 generates the output spectroscopic information GB on the basis of the spectroscopic information SS1 and SS2 (see FIG. 7).

As a result, the polarization degree information DP and the output spectroscopic information GB including the spectroscopic image for each wavelength band can be provided together to the application 40, and for example, various input information for machine learning can be provided.

According to the embodiment, an example has been described in which the spectroscopic information processing unit 10 generates the output spectroscopic information GB by combining the spectroscopic information SS1 and SS2 after canceling the parallax due to the arrangement of the spectroscopic cameras 30A and 30B (see FIG. 7).

The parallax generated in the spectroscopic information SS1 and SS2 is canceled by the arrangement of the spectroscopic cameras 30A and 30B and then combined to obtain the output spectroscopic information GB, whereby the accuracy of the spectroscopic information can be improved.

The information generation apparatus 50 according to the embodiment has been described as an example that includes the distance information calculation unit 20 that calculates the distance information DS from the spectroscopic information SS1 and SS2.

As a result, the polarization degree information DP and the distance information DS, or the polarization degree information DP, the output spectroscopic information GB, and the distance information DS can be provided together to the application 40, and for example, various input information for machine learning can be provided.

In other words, in a case where the spectroscopic cameras 30A and 30B are provided to obtain the polarization degree information DP, the distance information DS can also be obtained using the outputs of the spectroscopic cameras 30A and 30B.

According to the embodiment, an example has been described in which the distance information calculation unit 20 calculates the distance information DS using the luminance image G1 generated from the spectroscopic information SS1 and the luminance image G2 generated from the spectroscopic information SS2 (see FIG. 8).

The luminance images G1 and G2 suitable for pattern matching are generated from the spectroscopic information SS1 and SS2, which is suitable for distance calculation.

According to the embodiment, an example has been described in which the distance information calculation unit 20 calculates the parallax information D of the luminance image G1 and the luminance image G2, and calculates the distance information DS on the basis of the parallax information D (see FIG. 8).

The distance information DS (depth) can be obtained by obtaining the parallax information D of the luminance images G1 and G2 caused by the arrangement of the spectroscopic cameras 30A and 30B.

According to the embodiment, an example has been described in which the distance information calculation unit 20 performs processing of reducing the difference generated between the luminance images G1 and G2 with and without the polarizing filter 32 interposed, then calculates the parallax information D from the luminance images G1 and G2, and calculates the distance information DS on the basis of the parallax information D (see FIG. 11).

Since the luminance images G1 and G2 have a difference between an image without the polarizing filter 32 interposed and an interposed image, by correcting this difference, pattern matching accuracy can be improved, which is suitable for parallax measurement.

In the information generation system 100 according to the embodiment, the spectroscopic camera 30A and the spectroscopic camera 30B include the spectroscopic sensor 4 that captures images in a plurality of common wavelength bands.

With this configuration, each of the spectroscopic information SS1 and SS2 includes spectroscopic images of the same plurality of wavelength bands, so that the polarization degree information can be obtained by comparing the spectroscopic information for each channel.

Note that the effects described in the present specification are merely examples and are not limited, and other effects may be provided.

It should be understood by those skilled in the art that various modifications, combinations, sub-combinations and alterations may occur depending on design re-quirements and other factors insofar as they are within the scope of the appended claims or the equivalents thereof.

Note that the present technology can also employ the following configurations.

(1)

An information generation apparatus including
a spectroscopic information processing unit that generates polarization degree information that indicates wavelength dependency of a polarization degree from first spectroscopic information that is an imaging signal for each of a plurality of wavelength bands from a first spectroscopic camera and second spectroscopic information that is an imaging signal of the plurality of wavelength bands of light received by a second spectroscopic camera via a polarizing filter.
(2)

The information generation apparatus according to (1) described above, in which
the spectroscopic information processing unit generates the polarization degree information by obtaining a difference for each wavelength band between the first spectroscopic information and the second spectroscopic information.
   (3)

The information generation apparatus according to (1) or (2) described above, in which
the spectroscopic information processing unit generates output spectroscopic information on the basis of the first spectroscopic information and the second spectroscopic information.
   (4)

The information generation apparatus according to (3) described above, in which
the spectroscopic information processing unit generates the output spectroscopic information by combining the first spectroscopic information and the second spectroscopic information after canceling parallax caused by positional arrangement of the first spectroscopic camera and the second spectroscopic camera.
   (5)

The information generation apparatus according to any one of (1) to (4) described above, further including
a distance information calculation unit that calculates distance information from the first spectroscopic information and the second spectroscopic information.
   (6)

The information generation apparatus according to (5) described above, in which
the distance information calculation unit calculates distance information using a first luminance image generated from the first spectroscopic information and a second luminance image generated from the second spectroscopic information.
(7)

The information generation apparatus according to (5) or (6) described above, in which
the distance information calculation unit calculates parallax information between a first luminance image generated from the first spectroscopic information and a second luminance image generated from the second spectroscopic information and calculates the distance information on the basis of the parallax information.
   (8)

The information generation apparatus according to any one of (5) to (7) described above, in which
after performing processing of reducing a difference caused by presence or absence of a polarizing filter between a first luminance image generated from the first spectroscopic information and a second luminance image generated from the second spectroscopic information, the distance information calculation unit calculates parallax information between the first luminance image and the second luminance image and calculates the distance information on the basis of the parallax information.
   (9)

An information generation system including:
a first spectroscopic camera that outputs first spectroscopic information that is an imaging signal for each of a plurality of wavelength bands;
a second spectroscopic camera that outputs second spectroscopic information that is an imaging signal for the plurality of wavelength band of light received via a polarizing filter; and
a spectroscopic information processing unit that generates polarization degree information indicating a wavelength dependency of a polarization degree from the first spectroscopic information and the second spectroscopic information.
   (10)

The information generation system according to (9) described above, in which
the first spectroscopic camera and the second spectroscopic camera include a spectroscopic sensor that images a plurality of common wavelength bands.
   (11)

An information generation method including:
outputting, by a first spectroscopic camera, first spectroscopic information that is an imaging signal for each of a plurality of wavelength bands;
outputting, by a second spectroscopic camera, second spectroscopic information that is an imaging signal for the plurality of wavelength band, which are common with the first spectroscopic camera, of light received via a polarizing filter; and
generating polarization degree information that indicates a wavelength dependency of a polarization degree from the first spectroscopic information and the second spectroscopic information.

### REFERENCE SIGNS LIST

3 Spectroscopic camera
4 Spectroscopic sensor
10 Spectroscopic information processing unit
11 Space calibration unit
15 Information generation unit
20 Distance information calculation unit
30A, 30B Spectroscopic camera
32 Polarizing filter
40 Application
50 Processor (Information processing apparatus)
100 Information generation apparatus
SS1, SS2 Spectroscopic information
GB Output spectroscopic information
DD Polarization degree information
DS Distance information
G1, G2 Luminance image
D Parallax information

1. An information generation apparatus comprising
a spectroscopic information processing unit that generates polarization degree information that indicates wavelength dependency of a polarization degree from first spectroscopic information that is an imaging signal for each of a plurality of wavelength bands from a first spectroscopic camera and second spectroscopic information that is an imaging signal of the plurality of wavelength bands of light received by a second spectroscopic camera via a polarizing filter.

2. The information generation apparatus according to claim 1, wherein
the spectroscopic information processing unit generates the polarization degree information by obtaining a difference for each wavelength band between the first spectroscopic information and the second spectroscopic information.

3. The information generation apparatus according to claim 1, wherein
the spectroscopic information processing unit generates output spectroscopic information on the basis of the first spectroscopic information and the second spectroscopic information.

4. The information generation apparatus according to claim 3, wherein
the spectroscopic information processing unit generates the output spectroscopic information by combining the first spectroscopic information and the second spectroscopic information after canceling parallax caused by positional arrangement of the first spectroscopic camera and the second spectroscopic camera.

5. The information generation apparatus according to claim 1, further comprising
a distance information calculation unit that calculates distance information on the basis of the first spectroscopic information and the second spectroscopic information.

6. The information generation apparatus according to claim 5, wherein
the distance information calculation unit calculates distance information using a first luminance image generated from the first spectroscopic information and a second luminance image generated from the second spectroscopic information.

7. The information generation apparatus according to claim 5, wherein
the distance information calculation unit calculates parallax information between a first luminance image generated from the first spectroscopic information and a second luminance image generated from the second spectroscopic information and calculates the distance information on the basis of the parallax information.

8. The information generation apparatus according to claim 5, wherein
after performing processing of reducing a difference caused by presence or absence of a polarizing filter between a first luminance image generated from the first spectroscopic information and a second luminance image generated from the second spectroscopic information, the distance information calculation unit calculates parallax information between the first luminance image and the second luminance image and calculates the distance information on the basis of the parallax information.

9. An information generation system comprising:
a first spectroscopic camera that outputs first spectroscopic information that is an imaging signal for each of a plurality of wavelength bands;
a second spectroscopic camera that outputs second spectroscopic information that is an imaging signal for the plurality of wavelength band of light received via a polarizing filter; and
a spectroscopic information processing unit that generates polarization degree information indicating a wavelength dependency of a polarization degree from the first spectroscopic information and the second spectroscopic information.

10. The information generation system according to claim 9, wherein
the first spectroscopic camera and the second spectroscopic camera include a spectroscopic sensor that images a plurality of common wavelength bands.

11. An information generation method comprising:
outputting, by a first spectroscopic camera, first spectroscopic information that is an imaging signal for each of a plurality of wavelength bands;
outputting, by a second spectroscopic camera, second spectroscopic information that is an imaging signal for the plurality of wavelength band, which are common with the first spectroscopic camera, of light received via a polarizing filter; and
generating polarization degree information that indicates a wavelength dependency of a polarization degree from the first spectroscopic information and the second spectroscopic information.
